(19) United States
(12) Patent Application Publication
(10) Pub. No.: US 2008/0187228 A1
(43) Pub. Date: Aug. 7, 2008

(54) Activity detector

(75) Inventors: Anatoli Stobbe, Barsinghausen (DE); Hartmut Scheffler, Haste (DE)

Correspondence Address: COLLARD & ROE, P.C., 1077 NORTHERN BOULEVARD, ROSLYN, NY, 11576, US

(73) Assignee: ASTRA Gesellschaft für Asset Management mbH & Co. KG

(21) Appl. No.: 12/009,997

(22) Filed: Jan. 23, 2008

(30) Foreign Application Priority Data
Feb. 1, 2007 (DE) 10 2007 005 901.0

(51) Int. Cl. G06K 9/46

(52) U.S. Cl. 382/195

(57) ABSTRACT

An activity detector for the recording and transmission of activity data of an animal to a reader unit is described. The activity detector comprises a movement sensor, a recording and transmission unit connected with the movement sensor, and an energy source with an energy store supplying the recording and transmission unit. The activity detector furthermore includes an electrical generator converting kinetic energy into electrical energy, which is connected via a rectifier with the electrical energy store.

The invention concerns an activity detector according to the preamble of claim 1.

In the breeding and care of animals it is helpful to record data that is specific to particular animals, the analysis of which supplies information concerning behaviour, state of health and readiness for mating. Here what is important is the enabling of continuous data recording and prompt data analysis, even in free-range husbandry, without thereby limiting the periods for intake of food, inactivity, and activity that are desirable for each animal.

It is of known art to equip animals with a battery-powered activity detector that records and stores the activity data and enables transmission to a reader unit. In order to enable a continuous operation without any malfunctions a timely battery replacement is required, which is very time and labour consuming, since the animals must be captured, and are thus regularly disturbed.

The object of the invention is to create an activity detector that enables an autonomous, maintenance-free operation.

This object is achieved with an activity detector according to the preamble of claim 1 by means of the further features of this claim.

Further developments and advantageous embodiments ensue from the dependent claims.

In the solution according to the invention kinetic energy is converted by means of an electrical generator into electrical energy to power the recording and data transmission unit. By this means the electrical energy that is necessary to power the recording and data transmission unit is internally generated and stored automatically so that the periodic replacement of batteries can be eliminated.

The electrical generator can comprise an inertial body that can be displaced by the movements of the animal. As a result of the inertia the inertial body is displaced in the housing of the activity detector by the movements of the animal and thus enables the movement energy of the animal to be utilised indirectly for energy generation.

The inertial body can be designed as an eccentric that can be rotated or swivelled. Alternatively the inertial body can be designed as a pendulum.

The inertial body can thus describe a prescribed movement path, which enables a precise coupling with other mechanical or magnetic components.

Furthermore the inertial body can be coupled with a mechanical energy store, which can be discharged at intervals for the generation of electrical energy.

By this means it is possible to use a comparatively large impulse of mechanical energy for the electrical energy generation.

In a practical embodiment the electrical generator is formed by the movement sensor.

By means of the combined utilisation of the movement sensor as an electrical generator also, the complexity of components is reduced and a small build size achieved, which in turn has a positive effect on wearing comfort and engenders a low risk of damage.

The movement sensor comprises at least one permanent magnet routed on a movement path, as well as at least one induction coil arranged near the movement path.

By this means a high energetic efficiency is achieved.

The at least one permanent magnet is preferably supported as a pendulum in a swivel bearing.

This embodiment is mechanically particularly simple and low in friction. Electrical energy is generated by even the smallest pendulum movements and larger pendulum movements increase the energy output.

The at least one induction coil can be arranged on an armature, and the armature can have poles that flank the circular arc-shaped or spherical shell-shaped movement path of the at least one permanent magnet.

By this means a close coupling is achieved between the at least one permanent magnet and the at least one induction coil on the movement path of the permanent magnet. With further permanent magnets and/or induction coils and poles the movement length of the permanent magnets that can be used for energy generation can be increased, so that even large pendulum amplitudes can optimally be used to increase the energy output.

The electrical energy store can comprise a sub-store of large capacity and a sub-store of small capacity.

By means of the sub-store of small capacity a sufficient operating voltage is available after just a short charging time for the operation of the recording and transmission unit. After the sub-store of large capacity has been charged it can also bridge over phases of low energy generation at times when the animal is resting.

The sub-store of large capacity can be designed as a capacitor, or a chargeable accumulator, or a battery that can be buffered, and the sub-store of small capacity can be designed as a capacitor.

A capacitor or an accumulator tend to self-discharge, but either can be recharged, and while it is true that a battery cannot be charged, its life can be significantly extended by means of buffering.

The recording and transmission unit preferably includes a control logic module, a data store, a transmitter/receiver module for the LF range, namely a frequency range between 100 and 140 kHz, and an inductive aerial, wherein the control logic module includes a counter and a timer for the recording and storage of movement data from among movement impulses and movement amplitudes, interlinked with time stamps.

Exact movement data can thus be recorded with a high resolution, intermediately stored at exact times, and transmitted over a short distance at low power. This takes place by means of reader units with reader aerials in the vicinity of drinking troughs, feeding locations, refuges or milking parlours that are usually sought out regularly by the animals.

Furthermore in accordance with a data request received by the receiver the transmitter can be activated by means of the control logic module for the transmission of a stored identity number and the recorded and stored movement data, interlinked with time stamps.

By this means the transmission of stored data from the recording and transmission unit to the reader unit can be initiated by means of an external command from the reader unit. The transmitter of the transmission unit is then only activated if data reception is also guaranteed.

Furthermore the inductive aerial can in addition be designed as an energy receiver and connected with the charging unit.

By this means it is possible to equip the energy store of the activity detector, even before its installation on the animal, with a first or basic charge that then enables immediate data recording. There is no need to wait until the energy store has been gradually charged up by the movement sensor. Moreover supplementation of the charging of the energy store can also be undertaken if the animal remains in the vicinity of the reader aerial of a reader unit.

According to a further development additional sensors from among position sensors, temperature sensors, moisture sensors can be connected with the recording and transmission unit, and their data can likewise be stored and transmitted.

By means of these further sensors it is possible to extract additional animal-specific data, which can be evaluated together with the movement data and can provide supplementary conclusions concerning behaviour, state of health and readiness for mating, or can also be drawn on as a validity check on the movement data recorded.

The recording and transmission unit can include an additional receiver in the VLF range, namely in the frequency range between 6 and 10 kHz, in order to receive beacon data from location beacons, wherein the beacon data can likewise be stored and transmitted.

From the known locations of the beacons in conjunction with the beacon data a movement profile of the animal can thus be generated, which provides further supplementary conclusions concerning behaviour, state of health and readiness for mating.

The recording and transmission unit can include an additional transmitter in the UHF range, namely in the frequency range between 400 and 900 MHz, via which the stored data from among identity numbers, movement data, sensor data, beacon data interlinked with time stamps, or alarm signals generated from the combined analysis of data from among identity numbers, sensor data, beacon data, can be transmitted to a reader unit (54), controlled according to time, location, or event.

By this means stored data can also be transmitted independently of proximity to a reader aerial of a reader unit in the LF range, and can thereby be transmitted over a greater distance. This can take place at times that can be set, or also as a result of initialisation of a location beacon, whose beacon data can likewise be transmitted.

An event-controlled transmission by internal analysis and evaluation of the sensor data is also possible. By means of an internal analysis and evaluation of the sensor data alarm signals can also be generated and transmitted, if the animal in the event of injury, illness, death, breakout from a fenced-off area, or other impairments does not, or cannot, seek out the locations equipped with reader units and reader aerials for the LF range, or requires immediate help.

In what follows the invention is elucidated with the aid of examples of embodiment that are represented in the drawing.

In the drawing:

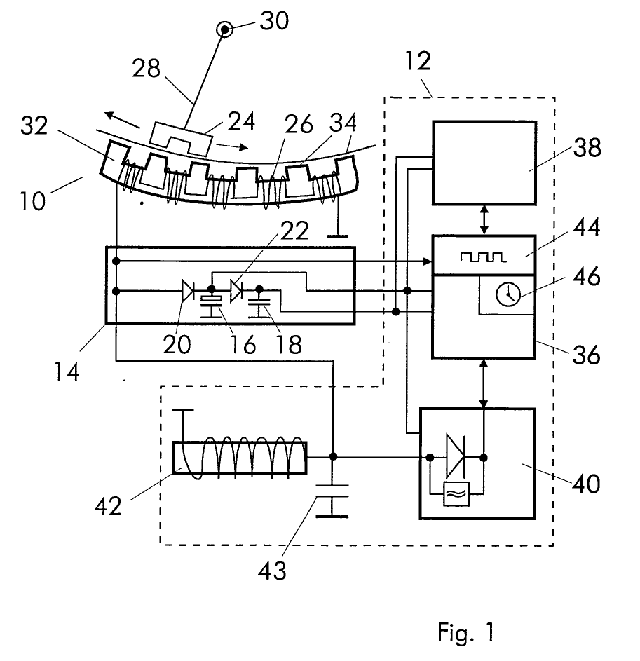

FIG. 1 shows a block circuit diagram of an activity detector with a movement sensor that in addition is designed as an electrical generator, and

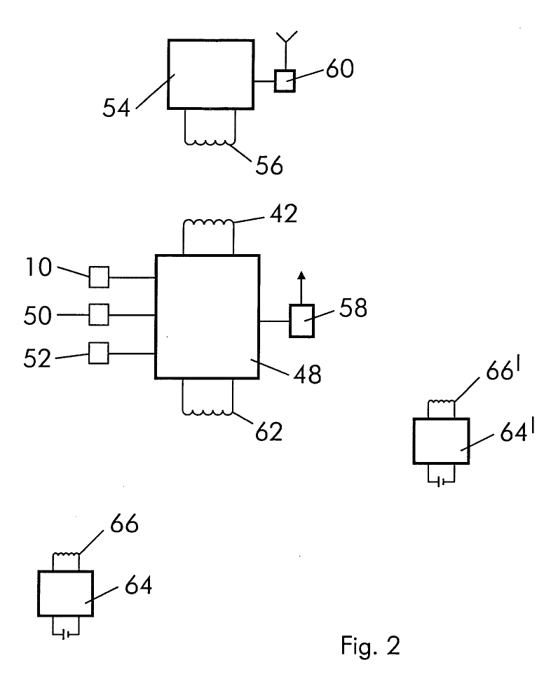

FIG. 2 shows a block circuit diagram with an expanded activity detector with a reader unit and with location beacons.

FIG. 1 shows a block circuit diagram of an activity detector with a movement sensor 10 that in addition is designed as an electrical generator. The activity detector comprises a recording and transmission unit 12 with a control logic module 36, a data store 38, a transmitter/receiver module 40 for the LF range, and an inductive aerial 42, which with a capacitor 43 forms an oscillating circuit. The control logic module 36 has as components a counter 44 and a timer 46.

The recording and transmission unit 12 is connected with an energy source 14 with an energy store 16, 18. The movement sensor 10 that in addition is designed as an electrical generator is connected via a rectifier 20, 22 with the energy store 16, 18. Here the energy store is divided into a sub-store 16 of large capacity and a sub-store 18 of small capacity to achieve a short charging time. The rectifier is also divided into a sub-rectifier 20 and a sub-rectifier 22.Here the sub-rectifier 22 decouples the sub-store 18 of small capacity from the sub-store 16 of large capacity, in order to prevent a discharge of the sub-store 18 through the sub-store 16.

The movement sensor 10 comprises a permanent magnet 24 supported as a pendulum 28 in a swivel bearing 30, which can swing over a circular arc-shaped movement path. Furthermore the movement sensor 10 comprises an armature 32 with induction coils 26 and poles 34, which flank the circular arc-shaped movement path of the permanent magnet 24. The induction coils 26 are connected via the rectifiers 20, 22 with the energy store 16, 18 of the energy source 14.

In the event of movement impulses of an animal in which the activity sensor is installed, the pendulum 28 starts to oscillate about its swivel joint 30. Here the permanent magnet 24 sweeps past the poles 34 of the armature 32 and by means of variations of the magnetic flux in the armature 32 induces electrical voltages in the induction coils 26. Here these take the form of alternating voltages, which are rectified by the rectifier 20, 22, and charge the energy store 16, 18, wherein firstly the sub-store 18 by virtue of its small capacity builds up an operating voltage that is sufficient for supply to the control logic module 36 and the data store 38, and subsequently the sub-store 16 can also supply the energy necessary for the operation of the transmitter/receiver module 40. Initial charging or supplementary charging of the energy store 16, 18 can also take place by means of HF energy supplied via the aerial 42 and rectification by means of the rectifier 20, 22.

The alternating voltage supplied by the movement sensor 10 is also supplied immediately to the control logic module and is recorded by means of a counter 44. In addition the amplitude of the alternating voltage can also be recorded. The pendulum movements recorded by the counter 44 via the alternating voltage represent a measure for the movement of the animal and, interlinked with time stamps of a timer 46, are stored in the data store 38.

For the interrogation of an identity number and the movement data interlinked with time stamps the transmitter/receiver module 40 receives via the inductive aerial 42 from a reader unit a request command, which is analysed by the control logic module 36.The control logic module 36 then activates the transmitter of the transmitter/receiver module 40 and transmits in sequence the identity number and the movement data interlinked with time stamps to the reader unit. The communication between the reader unit and the transmitter/receiver module 40 can take place, depending on the type of modulation used, in half-duplex or full-duplex mode.

In parallel to the data communication the inductive aerial 42 can also draw the electrical energy required for operation of the transmitter/receiver module, or for recharging the electrical store, from the reader unit 54.

FIG. 2 shows a schematic block diagram of an expanded activity detector 48 with a reader unit 54 and with location beacons 64, 64′. Apart from the movement sensor 10 other sensors 50, 52 are connected from among movement sensors, temperature sensors, and moisture sensors. The data from these sensors 50, 52, interlinked with time stamps, can also be intermediately stored in the data store and later transmitted to the reader unit 54 in the HF range via the inductive aerial 42 of the activity detector 48, and the inductive aerial 56 of the reader unit 54.

The activity detector 48 also possesses an additional UHF transmitter 58, via which stored data or alarm signals that are controlled by time or event can be transmitted to a UHF receiver 60 of the reader unit 54. By means of time control transmission can take place at specified time intervals. With event control a transmission can also be initiated by the recording of abnormal data from the sensors 10, 50, 52. These data can also be analysed as an alarm criterion and can generate an alarm signal, e.g. if the animal shows little or no movement activity over a longer period of time, indicating illness, injury or death, or is hyperactive, which can point to other dangerous influences.

In FIG. 2 location beacons 64, 64′ are also represented, which are erected at a plurality of locations and transmit beacon data. If the animal approaches the location beacons 64, 64′ the beacon data radiated from the beacon aerials 66, 66′ are received via an additional inductive aerial 62 and an additional receiver of the activity detector 48, and are likewise intermediately stored, interlinked with time stamps, in the data store. The beacon data interlinked with time stamps can likewise be transmitted to the reader unit 54, and enable the recording of the locations that can be identified by means of the beacon data, and thus the generation of a movement profile for the animal.

1. An activity detector for the recording and transmission of activity data of an animal to a reader unit (54), wherein
the activity detector comprises a movement sensor (10), a recording and transmission unit (12) connected with the movement sensor (10), and an energy source (14) with an electrical energy store (16, 18) supplying the recording and transmission unit (12),
wherein the activity detector includes an electrical generator converting kinetic energy into electrical energy, which is connected via a rectifier (20, 22) with the electrical energy store (16, 18).

2. The activity detector according to claim 1,
wherein the electrical generator includes an inertial body that can be displaced by the movements of the animal.

3. The activity detector according to claim 2,
wherein the inertial body is designed as an eccentric that can be rotated or swivelled.

4. The activity detector according to claim 2,
wherein the inertial body is designed as a pendulum.

5. The activity detector according to claim 2, wherein the inertial body is coupled with a mechanical energy store, which can be discharged at intervals for the generation of electrical energy.

6. The activity detector according to claim 1, wherein the electrical generator is formed by the movement sensor (10).

7. The activity detector according to claim 1, wherein the movement sensor (10) of the generator includes at least one permanent magnet (24), guided on a movement path, as well as at least one induction coil (26) arranged near the movement path.

8. The activity detector according to claim 7,
wherein the at least one permanent magnet (24) is supported as a pendulum (28) in a swivel bearing (30).

9. The activity detector according to claim 8,
wherein at least one induction coil (26) is arranged on an armature (32), and the armature (32) has poles 34, which flank the circular-shaped or spherical shell-shaped movement path of the at least one permanent magnet (24).

10. The activity detector according to claim 1, wherein the energy store comprises a sub-store (16) of large capacity and a sub-store (18) of small capacity.

11. The activity detector according to claim 10,
wherein the sub-store (16) of large capacity is designed as a capacitor or a chargeable accumulator, or a battery that can be buffered, and the sub-store (18) of small capacity is designed as a capacitor.

12. The activity detector according to claim 1, wherein the recording and transmission unit (12) comprises a control logic module (36), a data store (38), a transmitter/receiver module (40) for the LF range, and an inductive aerial (42), wherein
the control logic module (36) includes a counter (44) and a timer (46) for the recording and storage of movement data from among movement impulses and movement amplitudes, interlinked with time stamps.

13. The activity detector according to claim 1, wherein in accordance with a data request received by the receiver of the transmitter/receiver module (40) the transmitter of the transmitter/receiver module (40) can be activated by means of the control logic module (36) for the transmission of a stored identity number and the recorded and stored movement data interlinked with time stamps.

14. The activity detector according to claim 1, wherein the inductive aerial (42) in addition is designed as an energy receiver, and is connected with the rectifier (20, 22).

15. The activity detector according to claim 1, wherein additional sensors (50, 52) from among position sensors, temperature sensors, and motion sensors are connected with the recording and transmission unit (12), and their data can likewise be stored and transmitted.

16. The activity detector according to claim 1, wherein the recording and transmission unit (12) includes an additional receiver in the VLF range for the reception of beacon data from location beacons (64, 64′), and
in that the beacon data can likewise be stored and transmitted.

17. The activity detector according to claim 1, wherein the recording and transmission unit (12) includes an additional transmitter in the UHF range, via which stored data from among identity numbers, movement data, sensor data, beacon data interlinked with time stamps, or alarm signals generated from the combined analysis of data from among identity numbers, movement data, sensor data, beacon data, can be transmitted to a reader unit (54), controlled by time, location or event.
